(19) United States
(12) Patent Application Publication
(10) Pub. No.: US 2026/0365551 A1
(43) Pub. Date: Nov. 19, 2026

(54) Concentric Tubular Electrodeionization Module for Producing Ultrapure Water

(71) Applicant: Ovivo Inc., Montreal (CA)

(72) Inventors: Philippe Rychen, Muespach-le-haut (FR); Pierre-Emmanuel Panouillot, Mulhouse (FR); Cecile Albini, Durmenach (FR); Alexandre Devillers, Wittenheim (FR)

(73) Assignee: Ovivo Inc., Montreal (CA)

(21) Appl. No.: 19/212,420

(22) Filed: May 19, 2025

(51) Int. Cl. C02F 1/469; C02F 103/04

(52) U.S. Cl. CPC C02F 1/4695; C02F 2103/04; C02F 2201/002; C02F 2201/46115; C02F 2201/4617

(57) ABSTRACT

An electrodeionization module is formed as a cylinder containing a series of individual tubular cells as concentrating chambers, some anionic and some cationic, spaced apart in an array in the tubular module. Low voltage power is supplied to anodes and cathodes of the cells. The module has an inlet for infeed water, an outlet for ultrapure water and outlets for solid-carrying liquids and gases from the cationic and anionic cells. Surrounding each cathode and anode is a space containing a bed of resin media, within which salts are collected from the water. Clean water flows through the anionic and cationic cells, removing the salts and gases.

### BACKGROUND OF THE INVENTION

This invention concerns electrodeionization of water, to produce ultrapure water. The invention provides a modular, tubular electrodeionization unit with particular advantages.

Electrodeionization, or EDI, is a water purification technology utilizing DC power, ion exchange membranes, and ion exchange resin to deoionize water. Sometimes EDI follows reverse osmosis water treatment, to produce ultrapure water. EDI has the advantage of avoiding the need for chemical regeneration of mixed beds, by operating continuously via electrical hydrolysis. In EDI, a DC current continuously directs positive and negative ions toward electrodes having opposed electrical charges. The electric potential draws anions and cations from one or more diluting chambers, through cation and anion exchange membranes, into concentrating chambers. An ion exchange resin fills the diluting chamber or chambers. As input water flows through the resin bed, cations and anions attach to resin sites.

EDI avoids the need for chemical regeneration of mixed beds by effecting regeneration through electrolysis of the water induced by the electric current. Water is electrolyzed into hydrogen and hydroxyl ions to effectively regenerate the resin.

Conventionally, EDI modules have been in a plate and frame configuration, which involves a very large number of flat gaskets, with risk of leakage, or a spiral wound module configuration. In addition, many spiral wound modules utilize a high voltage, up to 100 volts DC, and plate and frame modules have utilized up to 600 volts DC. There can be safety issues, as hydrogen and oxygen are emitted and sometimes not well isolated from each other.

The following patent documents show conventional electrodeionization systems: U.S. Pat. Nos. 5,738,023, 9,566,044, 10,442,708; U.S. Pub. No. 2024/0182330; Japanese Patent No. JP3174036U and Korean Patent No. KR20180113509A.

### SUMMARY OF THE INVENTION

With the invention an electrodeionization (EDI) module is formed in a mass-producible configuration, preferably cylindrical or cuboid, providing a robust module with high demineralization performance. The module features a fully closed and concentric electric field that enhances removal of weakly dissociated species such as carbon dioxide, silica, boron and organics. The modules of the invention involve mainly O-ring seals.

In addition, the low voltage power supply, no greater than 24 volts, is safer and more easily handled specially in water environment as well as less costly to produce.

The units or modules utilize standardized equipment, including an inlet nozzle or fitting for feedwater, an outlet nozzle or fitting for ultrapure water and two nozzles-fitting carrying liquids and gases from the concentrate compartments or cells within which the electrodes are contained. Hydrogen and oxygen exiting gases are well separated.

The EDI module includes a plurality of the concentrate cells, called herein membrane electrode resin assembly (MERA), including cathodic MERA and anodic MERA. Each cathodic MERA includes a cationic membrane and cationic resin or mixed resins contained in the MERA and surrounding the cathode. Each anodic MERA has anionic membrane, an anionic resin or mixed resin contained in the MERA and surrounding the anode. The anode itself is surrounded by a protective membrane.

In a preferred embodiment the ion exchange membranes of the MERAs are formed to cylindrical tubes through welding, gluing or extrusion, the membrane and tubular assembly serving as containment of electrodes and resin. With the module of the invention each concentrate compartment is concentric with an electrode at center, surrounded by resin that is contained by the membranes.

In preferred embodiments the cation MERAs and anion MERAs can be arrayed in several different ways. With numerous of the MERAs contained in a module, they can be arranged in concentric rings or in a “flower” configuration, or other desired arrangements, provided appropriate separation distance is provided between adjacent cathode and anode MERAs.

Between cation and anion MERAs, a dilute chamber is formed and contains anion-cation layers or mixed bed ion exchange resins. These are preferably a strong cation exchange resin and a strong base anion exchange resin. The volume of the mixed bed resin of the dilute chamber depends on module size.

With a 24 volt power supply, the continuous electric field is maintained between anodic MERAs and cathodic MERAs, causing the ions in the infeed water, flowing through the dilute compartment, to be attracted toward the opposing polarity electrode compartment. Electric field is causing continuous regeneration of the IEX resins through water splitting.

Salinity is concentrated in the cathodic MERA compartments and anodic MERA compartments, but this is continuously flushed out of those compartments by continuous feed of pure water, which can be previously produced pure water, through these compartments. This flushing water can be fed upwardly through the compartments, capturing the ions that have permeated through the permselective ion exchange membranes, to be drained out together with the gas produced by electrolysis at the electrodes.

Modules produced according to the invention can have a flow capacity of 0.5 to 1.5 cubic meters per hour or higher, even up to 20 cubic meters per hour, depending primarily on diameter of the module, larger modules having a higher number of MERA cylinders and greater ion exchange bed volume. Integrity, reliability and efficiency of the module are increased by the embodiments of the invention.

These and other advantages and features of the invention will be apparent from the following description of a preferred embodiment, considered along with the accompanying drawings.

### DESCRIPTION OF THE DRAWINGS

FIG. 1 is a schematic view in section showing an individual electrode/resin compartment or MERA that forms a part of the invention.

FIGS. 2A and 2B are perspective (partially cut away) and sectional views showing a MERA cell.

FIGS. 3, 4 and 5 show different patterns of MERA cells within a electrodeionization module of the invention.

FIG. 6 is a schematic section view demonstrating the arrangement of MERA cells within a module, showing only two MERA for purposes of clarity.

FIG. 7 is a schematic view similar to FIG. 6, and indicating the flow of feedwater water through the dilute region of the EDI module, with a portion of the pure water flowing back up through the cathode MERA cell and through the anode MERA cell, for removal of contaminants and gases.

FIG. 8 is similar to FIG. 6 but further indicating the flow of cations and anions through membranes into the MERA cells where the cathode and anode reside.

FIG. 9 is a perspective view showing a preferred form of the EDI module.

FIG. 10 is a partial sectional view showing an EDI module of the invention, with anode and cathode MERA fluidly connected to respective outlet ports for discharge of salts, contaminants and gases along with separate flows of water out of the module.

### DESCRIPTION OF PREFERRED EMBODIMENTS

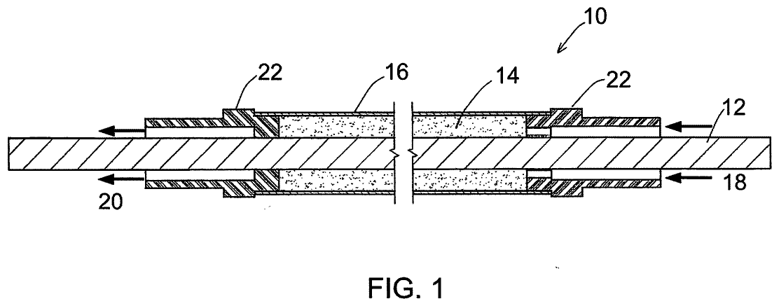

In the drawings, FIG. 1 shows in longitudinal cross-section a cell or MERA which is included in the invention. The MERA 10 includes an electrode 12, either an anode or a cathode, surrounded by an ion exchange resin 14 filled into a space surrounding the electrode. The resin 14 is a cation resin, an anion resin or a mixed bed resin including both. The MERA 10 is enclosed with a membrane 16, which is either a cation exchange membrane or an anion exchange membrane.

In an embodiment of the invention, as will be discussed below, water is caused to flow upwardly through the cell 10, exiting the top of the cell, as indicated by the arrows 18 and 20. Fittings 22 secure a watertight relationship to the membrane shell 16 and enclose the ion-exchange resin into the cell 10 as shown. The electrode 12 is connected to the voltage source, preferably no greater than 24 volts DC.

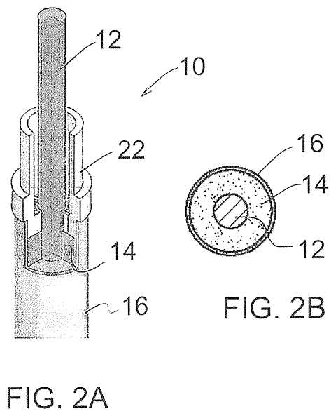

In FIG. 2 the MERA cell 10 is shown in perspective, partially cut away. The electrode 12 is centered in the cylindrical body of the MERA cell by the fitting 22. Ion exchange resin is shown at 14 surrounding the electrode, held by the membrane 16 and fitting 22 as discussed above.

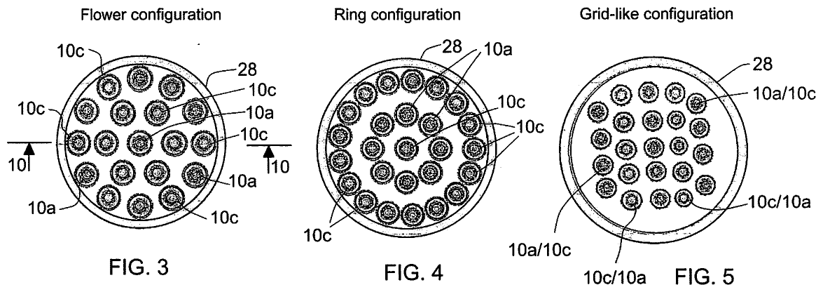

FIGS. 3, 4 and 5 show examples of different arrangements of a multiplicity of MERA cells as contained in a module cylinder 28. FIG. 3 shows a “flower” configuration; FIG. 4 a concentric ring configuration; and FIG. 5 a grid-like configuration. The anionic MERA cells 10a and the cationic MERA cells 10c are interspersed in a way that distributes them generally evenly with approximately uniform space between and among them. In FIG. 4 the outer ring and the central cell are cationic MERA, while the inner ring has anionic MERA. These arrangements are examples; depending on configuration, the anion and cationic MERA can be exchanged in position.

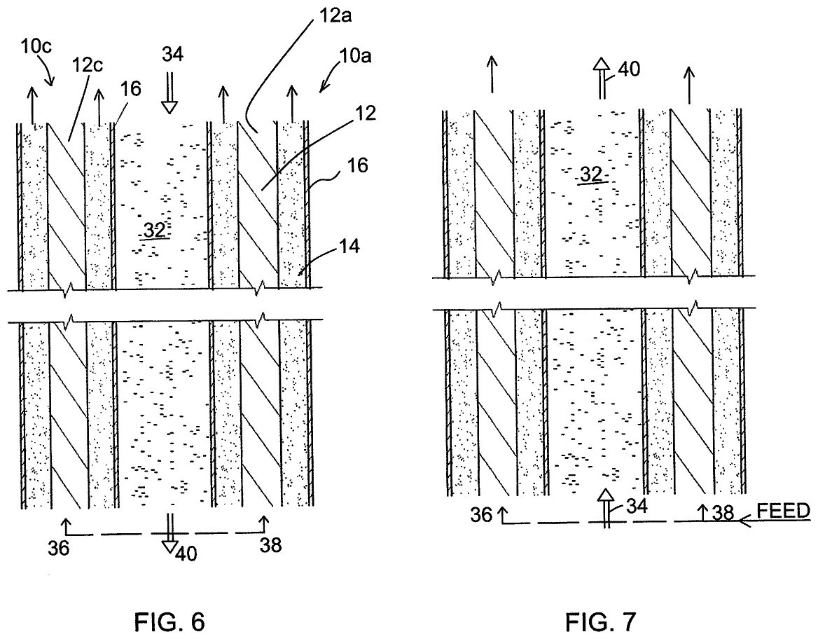

FIG. 6 shows schematically what can be considered a portion of an EDI module, showing only two adjacent MERA, a cationic MERA 10c and anionic MERA 10a, for purpose of illustration. Between the cathode and anode MERA is a mixed bed resin 32 of cation and anion resin, as typically used in electrodeionization. As shown in FIG. 6, the feedwater 34 can be directed downwardly through the mixed resin bed 32, then a portion of the feedwater being fed upwardly through the MERA cells, i.e. through the space surrounding each electrode. This is indicated at arrows 36 and 38, with continued arrows indicating exit near the top of the module. The bulk of the purified, deionized water is directed out of the module at 40.

FIG. 7 shows a variation of the flow shown in FIG. 6, with feedwater 34 entering at the bottom of the module and a portion of the feedwater being used to wash through the two illustrated MERA, the cathode MERA and the anode MERA. This feedwater is not ultrapure, but typically has been treated by reverse osmosis and is pure enough to be passed through the resin beds 14 to remove the salts, contaminants and gases.

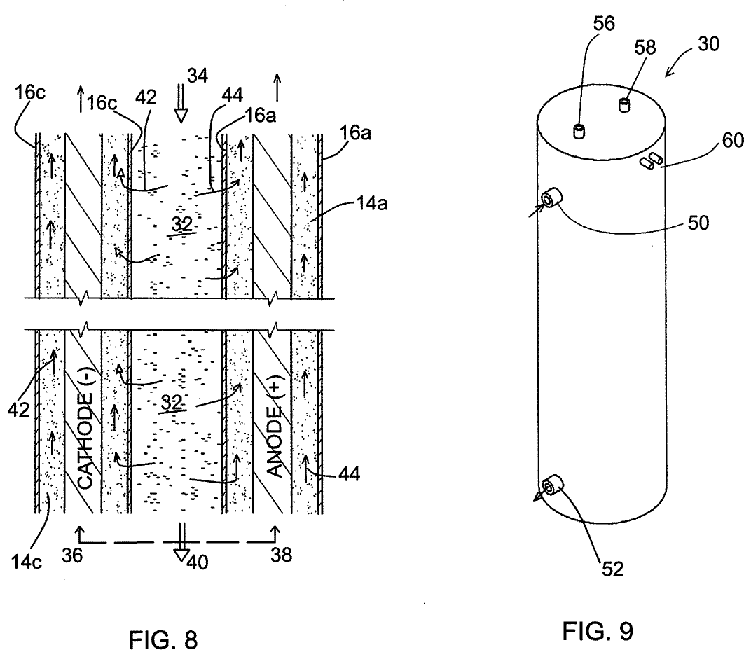

In FIG. 8 the water flow is shown as in FIG. 6, this figure also indicating flow of cations and anions. As the feedwater passes down through the resin bed 32, its ionic contaminants are drawn away through the resin 32 toward the respective MERA, cathode or anode. Cations, with positive charge, are indicated at 42 and are drawn through the cationic exchange membrane 16c to the cathode 16c chamber, into the resin 14c therein. Meanwhile, anions, indicated at 44, migrate toward the anode 12a and into the resin 14a surrounding that cathode, passing through the membrane 16a. Cations are indicated by arrows as entering the MERA 10c through the membrane 16c and rising; movement of anions to the anode 12a is similarly indicated by arrows. The bed 32 is considered a dilute chamber, while the spaces within the MERA 10c and 10a are concentrated with the removed salts and contaminants.

As in previous electrodeionization systems, the mixed bed resin 32 positioned in the flow of water and extending between the cathode and anode, serves to maintain stable conductance across the feedwater as the process continues with electrolyte flow to the electrodes. Without this medium the water alone would not be conductive enough to continue the process. Further, with adequate current flowing through the cathode and the anode, i.e. higher than necessary for movement of the ions, a portion of the feedwater will be electrolyzed, forming hydrogen (H⁺) cations and hydroxide (OH⁻) anions. These replace the impurity ions and cations in the resin, the process being known as in situ regeneration of the resin. This allows for continuous purification of the resin, as distinguished from deionization which requires a pause in the process to allow chemical regeneration of ion exchange resins. Thus, hydrogen and hydroxide are produced as the result of the continuous regeneration, and hydrogen and oxygen are removed along with salts and impurities gathered in the cells or MERA 10c and 10a.

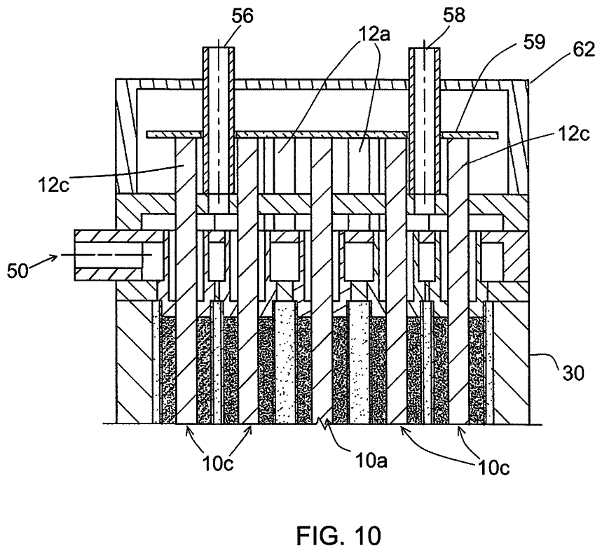

FIGS. 9 and 10 show the electrodeionization module 30 in perspective and schematic cross section. The feedwater enters the module at an inlet port 50 which is near the top of the apparatus in this illustrated embodiment (although the entry could be elsewhere). The upper location is in keeping with the preferred flow of feedwater down through the mixed bed, i.e. through the dilute chamber. FIG. 9 shows the inlet port 50 and an outlet port 52 which is located near the bottom of the unit. As illustrated, the module 30 preferably is elongated and cylindrical or approximately cylindrical (although the term “tubular” is intended to include other cross-sectioned shapes such as square or polygonal).

Cationic concentration cells or MERA are shown in FIG. 10 at 10c, while anionic concentration cells are shown at 10a. An outlet port is shown at 56 in FIGS. 9 and 10 for liquid/salts and gas from all anode MERA cells, collected in a common anode chamber or manifold in the unit (not shown). A second exterior outlet 58 for exit of all cationic MERA is also shown, connected to the upper ends of all cationic MERA (collection manifold not shown).

FIG. 10 shows that electrical connections are provided at the top (could be at the bottom) of the module to all cathodes and to all anodes, via electrical plates, one of which is indicated at 59. This can be via a single printed circuit board, or via two separate copper plates. FIG. 10 shows a single plate 59 with a printed circuit board that connects respectively to all anodes. The single PCB (or two plates) is connected to a main power connection shown at 60 in FIG. 9.

FIG. 10 is a cross section as seen through the center of a module 30 having the “flower” configuration of MERA cells as in FIG. 3. Thus, the five cells in the foreground are two cathodic, a center anodic, and two cathodic cells, while two cathodic cells are seen behind.

As shown in FIG. 9, the cylindrical body of the electrodeionization module 30 has a sealed upper cap 62 and a sealed lower base cap 64.

As expressed herein, “about” or “approximately”, or “essentially equal” should be understood to encompass plus or minus 20%.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. An electrodeionization apparatus for producing ultrapure water, comprising:
a tubular enclosure defining an electrodeionization module,
the enclosure containing a mixed bed ion exchange resin,
a series of cationic membrane electrode resin assemblies (MERAs) and a series of anionic MERAs within the enclosure and within and surrounded by the mixed ion exchange resin which defines a diluate chamber of the module, each MERA being elongated and oriented vertically,
each MERA being cylindrical and including a central electrode extending through the MERA, with an ion exchange resin surrounding the electrode and contained within the MERA by an ion exchange membrane outside of which is the mixed bed ion exchange resin, the electrode in the cationic MERA being a cathode and the electrode in the anionic MERA being an anode,
an electrical supply applying a negative charge to the cathodes and a positive charge to the anodes,
an inlet at one end of the enclosure for feedwater to flow through the mixed bed ion exchange resin,
an outlet at an opposite end of the enclosure for deionized water exiting the mixed bed ion exchange resin,
an inlet at a first end of each MERA, for flushing water to be directed through the MERA to remove salts, impurities and gases collected at the electrodes, and an outlet for the water, salts and impurities at a second end of each MERA, and
a first common collection volume in the enclosure for the water, salts and impurities from all cationic MERAs and a second common collection volume in the enclosure for the water, salts and impurities from all anionic MERAs,
whereby in operation the cathodes of the cationic MERA draw cations of impurities from the feedwater and through the ion exchange membrane to the cathodes, from which impurities are carried out of the module, and the anodes draw anions carrying impurities through the ion exchange membranes to the anodes, from which impurities are carried out of the module, the voltage of the electrical supply being higher than required to draw the cations and anions to the electrodes and sufficient to electrolyze some of the feedwater passing through the mixed bed resin so as to form hydrogen cations and hydroxide anions which replace the impurity cations and anions in the mixed bed resin to cause in situ regeneration of the mixed bed resin.

2. The apparatus of claim 1, wherein the electrical supply is at no more than about 24 volts.

3. The apparatus of claim 1, wherein the flushing water is supplied from the deionized water exiting the mixed bed ion exchange resin.

4. The apparatus of claim 1, including at least 6 MERAs.

5. The apparatus of claim 1, including at least 15 MERAs.

6. The apparatus of claim 1, including at least 20 MERAs.

7. The apparatus of claim 1, wherein the cathodic MERAs contain cationic resin, and the anodic MERAs contain anionic resin.

8. The apparatus of claim 1, wherein both cathodic and anodic MERAs contain mixed bed resins.

9. The apparatus of claim 1, wherein both cathodic and anodic MERAs contain anion cation stratified bed resins.

10. The apparatus of claim 1, wherein each of the cathodes and anodes is protected by a surrounding membrane.

11. The apparatus of claim 1, wherein mixed bed resin in the diluate chamber of the module is a stratified bed resin.

12. The apparatus of claim 1, wherein the module is elongated and oriented vertically, and the feedwater has a downward flow direction.

13. The apparatus of claim 1, wherein the module is elongated and oriented vertically, and the feedwater has upward flow direction.

14. The apparatus of claim 1, wherein the module is elongated on a vertical axis, and said first ends of the MERAs are bottom ends of the MERAs.

15. The apparatus of claim 1, wherein the module is elongated on a vertical axis, and said first ends of the MERAs are upper ends of the MERAs.

16. The apparatus of claim 1, wherein the tubular enclosure is cylindrical.

17. The apparatus of claim 1, wherein the flushing water has a downward direction of flow through the MERA cells.

18. The apparatus of claim 1, wherein the flushing water has an upward direction of flow through the MERA cells.

19. The apparatus of claim 1, wherein the cationic MERAs are essentially equal in number to the anionic MERA.

20. The apparatus of claim 1, including at least one anionic MERA for every four cationic MERAs.

21. The apparatus of claim 1, including one cationic MERA for every two or more anionic MERAs.

22. The apparatus of claim 1, including at least one anionic MERA for every six cationic MERAs.
